(19) United States
(12) Patent Application Publication
(10) Pub. No.: US 2026/0131327 A1
(43) Pub. Date: May 14, 2026

(54) Method of Manufacturing a Stacked Material for a Point-of-Care Testing System

(71) Applicant: Google LLC, Mountain View, CA (US)

(72) Inventors: Herschel Max Watkins, Sausalito, CA (US); Javier L. Prieto, Oakland, CA (US); Kristy Mckeating, San Francisco, CA (US)

(21) Appl. No.: 19/111,644

(22) PCT Filed: Sep. 16, 2022
(86) PCT No.: PCT/US2022/043773

§ 371 Date: Mar. 13, 2025

(51) Int. Cl. B01L 3/00

(52) U.S. Cl. CPC B01L 3/502707; B01L 2200/025; B01L 2200/12; B01L 2200/16; B01L 2300/069; B01L 2300/0887; B01L 2300/12

(57) ABSTRACT

A method of manufacturing a stacked material for a point-of-care (POC) testing system includes providing a first membrane comprising a first set of assay reagents and providing a second membrane. The method also includes coating the second membrane with a second set of assay reagents and a polymer coating solution. Further, the method includes arranging the first and second membranes in a stacked configuration, wherein the polymer coating solution adheres the first and second membranes together. Thus, the method also includes at least partially drying the stacked configuration to form the stacked material for the POC testing system.

### FIELD

The present disclosure relates generally to a point-of-care (POC) testing system that includes a stacked material, such as an assay stack, for collecting a target analyte sample for testing and more particularly, to methods of manufacturing such stacked materials.

### BACKGROUND

Point-of-care (POC) testing refers to performing medical diagnostic tests at the time and place that the patient is being treated. POC testing is advantageous over traditional diagnostic testing where patient samples are sent out to a laboratory for further analysis, because the results of traditional diagnostic tests may not be available for hours, if not days or weeks, making it difficult for a caregiver to assess the proper course of treatment in the interim.

An example POC testing system is configured to implement a vertical flow assay that includes an easy-to-handle cartridge having a protective shell for a microfluidic distribution system and assay components housed therein. During sample collection, the cartridge is brought into contact with a fluid sample that is drawn into a channel. The channel is in fluid communication with a metering stack and an assay stack. The assay stack and/or the metering stack are typically formed by assembling multiple layers. Accordingly, the metering stack can be used to collect the fluid sample and the assay stack can include assay components necessary for a target analyte (e.g., glucose) concentration assay to be carried out. Generally, the fluid sample is drawn into the channel by capillary action and then through the metering stack and the assay stack to implement one or more assay reactions that provide information regarding the contents of the fluid sample.

Thus, the assay stack and/or the metering stack of such POC testing systems rely on uniform, high-quality contact between the layers to allow efficient fluid flow therethrough. Accordingly, the present disclosure is directed to improved methods of manufacturing stacked materials for POC testing systems, such as POC testing systems that implement vertical flow assays.

### SUMMARY

Aspects and advantages of embodiments of the present disclosure will be set forth in part in the following description, or can be learned from the description, or can be learned through practice of the embodiments.

In an aspect, the present disclosure is directed to a method of manufacturing a stacked material for a point-of-care (POC) testing system. The method includes providing a first membrane comprising a first set of assay reagents and providing a second membrane. The method also includes coating the second membrane with a second set of assay reagents and a polymer coating solution. Further, the method includes arranging the first and second membranes in a stacked configuration, wherein the polymer coating solution adheres the first and second membranes together. Thus, the method also includes at least partially drying the stacked configuration to form the stacked material for the POC testing system.

In another aspect, the present disclosure is directed to a stacked material for a point-of-care (POC) testing system. The stacked material includes a first membrane having a first set of assay reagents. The stacked material also includes a second membrane arranged in a stacked configuration with the first membrane. The second membrane further includes a second set of assay reagents. The stacked material further includes a polymer coating solution blended with at least one of the first set of assay reagents and the second set of assay reagents. As such, the polymer coating solution adheres the first and second membranes together.

In yet another aspect, the present disclosure is directed to a method of manufacturing a point-of-care (POC) testing system configured to implement a vertical flow assay. The method includes providing a first membrane comprising a first set of assay reagents and providing a second membrane. The method also includes coating the second membrane with a second set of assay reagents and a polymer coating solution. Further, the method includes arranging the first and second membranes in a stacked configuration, wherein the polymer coating solution adheres the first and second membranes together. Moreover, the method includes at least partially drying the stacked configuration to form an assay stack. Thus, the method includes arranging the assay stack in a housing of the POC testing system configured to implement the vertical flow assay.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 provides a schematic drawing of a system including a cartridge and an assay reader according to one embodiment of the disclosure;

FIGS. 2A-2C illustrate an embodiment of the cartridge utilized in the system;

FIG. 3 illustrates various layers of a metering stack contained within the cartridge;

FIG. 4 illustrates various layers of an assay stack contained within the cartridge;

FIG. 5A shows a longitudinal cross-sectional view of an assay reader according to one embodiment of the disclosure;

FIG. 5B shows a longitudinal cross-sectional view of an assay reader with an inserted cartridge according to one embodiment of the disclosure;

FIG. 6A shows a transverse cross-sectional view of an assay reader according to one embodiment of the disclosure;

FIG. 6B shows a transverse cross sectional view of the assay reader with an inserted cartridge according to one embodiment of the disclosure;

FIG. 7 provides a flow diagram of an embodiment of a method of manufacturing a POC testing system according to the present disclosure;

FIG. 8 provides a cross-sectional view of an embodiment of a stacked material for a POC testing system manufactured using methods according to the present disclosure; and

FIG. 9 provides a schematic diagram of an embodiment of a system for manufacturing stacked materials for a POC testing system according to the present disclosure.

Reference numerals that are repeated across plural figures are intended to identify the same features in various implementations.

### DETAILED DESCRIPTION

Any of the features, components, or details of any of the arrangements or embodiments disclosed in this application, including without limitation any of the cartridge and methods of manufacturing embodiments and any of the testing or assay embodiments disclosed below, are interchangeably combinable with any other features, components, or details of any of the arrangements or embodiments disclosed herein to form new arrangements and embodiments.

Generally, the present disclosure is related to a method of manufacturing a stacked material for a point-of-care (POC) testing system, such as a POC testing system implementing a vertical flow assay. In particular, the method includes providing a first membrane containing a first set of assay reagents and providing a second membrane. Further, the method includes coating the second membrane with a second set of assay reagents and a polymer coating solution. For example, in an embodiment, coating the second membrane with the second set of assay reagents and the polymer coating solution may include applying the second set of assay reagents and the polymer coating solution to a use area of the second membrane. As used herein, the use area generally corresponds to an area of the assay stack in which a fluid sample passes through during operation of the POC testing system. The method also includes arranging the first and second membranes in a stacked configuration, wherein the polymer coating solution adheres the first and second membranes together. Moreover, the method includes at least partially drying the stacked configuration to form the stacked material for the POC testing system. The stacked material can then be used in the POC testing system, such as in a POC testing system as an assay stack.

As such, methods of manufacturing the stacked material of the present disclosure provides various benefits not present in the prior art, such as providing improved efficiency of the manufacturing process. In particular, an additional adhesion or alignment step is not required by coating the second membrane with the second assay reagent and the polymer coating solution. Thus, an additional adhesion layer is also not present or required in the final stacked material, thereby allowing a fluid sample to uniformly pass therethrough. In addition, in certain embodiments, methods of the present disclosure may be easily automated. It should be further understood that the stacked materials described herein may further be suitable for any POC testing system such as those that implement vertical flow assays, as well as lateral flow assays. Moreover, it should be understood that the first membrane may also be coated with the polymer coating solution or only the first membrane may be coated with the polymer coating solution.

With reference now to the figures, example embodiments of the present disclosure will be discussed in further detail.

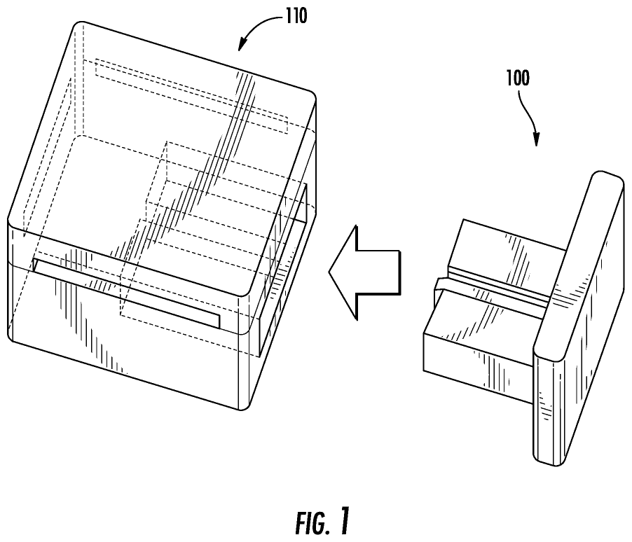

FIG. 1 shows a point-of-care (POC) testing system according to one exemplary embodiment of the present disclosure. The POC testing system includes a cartridge 100 (comprising an embodiment of a proposed assay device) and an assay reader 110. As described herein, cartridge 100 is used to collect a fluid sample that may contain a target analyte such as glucose, as well as any other target analytes of interest that the POC testing system is configured to measure. The collection process also distributes the fluid sample within cartridge 100. After the fluid sample is collected in cartridge 100, the user inserts cartridge 100 into assay reader 110. As described herein, the act of inserting cartridge 100 into assay reader 110 results in the compression of cartridge 100, thereby causing the fluid sample to be distributed to a separation membrane portion of an assay stack, the details of which are discussed in more detail below. In this way, the act of inserting cartridge 100 into assay reader 110 commences one or more assay reactions that provide information regarding the contents of the fluid sample. However, it is also to be understood that other insertion approaches are contemplated that do not require compression. Further, it is to be understood that while multiple assays can be utilized to determine the contents of a target analyte in the fluid sample, each assay is generally specific for one particular target analyte. As described herein, assay reader 110 is equipped with a detection system that is used to detect the results of the one or more assay reactions that occur at one or more membranes in an assay stack of cartridge 100. The detection system is not particularly limited and may be a detection system which causes a measurable signal change as the result of an assay reaction. Non-limiting examples of suitable detection systems include colorimetric, fluorescence, electrochemical, and optical detection systems as described herein and any other detection system that would be understood by one of ordinary skill in the art.

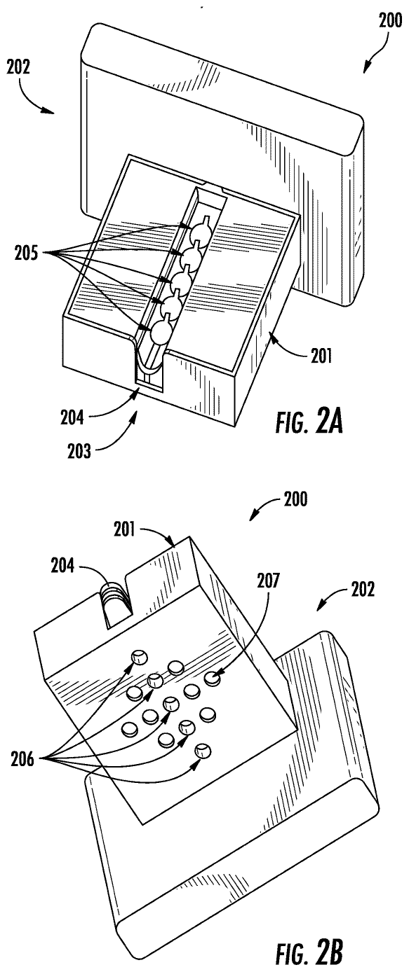

FIG. 2A illustrates a top, perspective view of an embodiment of cartridge 100 in the form of a cartridge 200. In FIG. 2A, cartridge 200 includes a housing 201 attached to a handle 202. In general, cartridge 200 is designed to be easy to handle by the user and to provide a protective shell for the microfluidic distribution system and assay components housed within cartridge 200. In general, suitable materials for housing 201 and handle 202 include polyolefinic compounds, such as polyethylene, polypropylene, and other polymeric resins or compounds known in the medical device manufacturing industry. During sample collection, cartridge 200 is brought into contact with a fluid sample (e.g., such as a blood sample). The fluid sample is drawn into channel 203 and via channel opening 204 by capillary action. In some embodiments, channel 203 includes a plurality of receiving chambers 205 located along channel 203. In some embodiments, each receiving chamber can be positioned between two venting holes, which facilitate the division of the fluid sample in the channel into multiple aliquots which flow to the assay stack. It should be recognized that the channel opening 204 can function as a venting hole and that neighboring receiving chambers can share a common venting hole between them. The venting holes can help to prevent unwanted bubble formation as the fluid sample is drawn into the receiving chambers.

FIG. 2B illustrates a bottom view of an embodiment of the cartridge 200. In FIG. 2B, the bottom portion of housing 201 includes a plurality of assay detection ports 206 The assay detection ports 206 permit the assay results to be interrogated, for example, by optical detection methods as described herein. In addition, the bottom portion of housing 201 may include a plurality of holes 207, which are additional assay detection ports that may be used with assay components and microfluidic channels that are arranged in a corresponding configuration.

FIG. 2C provides an exploded view of the components of the cartridge 200, according to one embodiment of the present disclosure. In FIG. 2C, the outer shell of cartridge 200 includes the handle 202, bottom housing portion 227, and a cap 223 that is equipped with a slot 228. The enclosure shape of the bottom housing portion 227 protects the components within the interior chamber and can avoid accidental actuation of the system. The cap 223 can fit to the open side of the bottom housing portion 227 and have a shape and size that corresponds to the open side of the bottom housing portion 227. When the bottom housing portion 227 and cap 223 of the housing are assembled together, an interior chamber can be formed for enclosing other components of the cartridge within the interior chamber. In other embodiments, the cap 223 and bottom housing portion 227 do not form an enclosure with an interior chamber and can be rigid structures positioned on the top of a metering stack and bottom of an assay stack, which are described herein.

In preferred embodiments, bottom housing portion 227 and cap 223 can be formed of a material to provide a rigid structure to the cartridge 200. For example, the bottom housing portion 227 and the cap 223 can be a plastic material, as described herein. The bottom housing portion 227 and cap 223 can be moveable or non-moveable with relation to each other. In some embodiments, when cartridge 200 is inserted into an assay reader, the components within the interior chamber are compressed to cause at least one portion of the collected fluid sample to be delivered to a plurality of assay components. The compression can be caused by the user closing a lid of the assay reader, for example. However, it is also to be understood that other approaches for insertion of the cartridge 200 into an assay reader are contemplated that do not require compression.

In some embodiments, the cartridge 200 does not include a cap and bottom housing portion. In such embodiments, the cartridge 200 does not include the housing 201 (see e.g., FIG. 2A) and the metering stack and assay stack can be inserted into an assay reader without an enclosure around it.

As shown in FIG. 2C, cartridge 200 can include a metering stack 224, a spacer material 225, and an assay stack 226. The metering stack 224 can be used to collect a sample of a biological fluid (e.g., a blood fluid sample) and the assay stack 226 can include assay components necessary for a target analyte (e.g., glucose) concentration assay to be carried out through one or more of the receiving chambers 205 as discussed in detail herein. However, it should also be understood that other assays (e.g., immunoassays or enzymatic assays) may also be carried out in additional receiving chambers 205 and the assay stacks 226 associated with each receiving chamber 205 can each be unique based on the particular assay associated with each receiving chamber 205. As used herein, the term “metering” refers to collecting a liquid sample of a biological fluid and delivering one or more predetermined volumes of at least a portion of the fluid to the assay components for further analysis via the assay components contained in the assay stack. When assembled into the cartridge 200, the metering stack 224, a spacer material 225, and an assay stack 226 can be arranged in a stack.

The spacer material 225 is a compressible layer that may be positioned between the metering stack 224 and assay stack 226 as shown in FIG. 2C. In an embodiment, the spacer material 225 may be a flexible material that can be compressed in the vertical direction when the cartridge is inserted into the assay reader and the metering stack 224 is moved into contact with or close proximity to the assay stack 226. In some embodiments, the spacer material 225 can be a flexible material, such as foam, rubber, porous polymer, metal, cotton, or other bending, folding, or moving mechanisms such as a clamp or spring. In some embodiments, the metering and assay stacks are initially separated by an air gap maintained by the spacer material 225. In certain embodiments, spacer material 225 is physically affixed to another layer, such as metering stack 224 or assay stack 226 before the layers of the cartridge 200 are brought together. Typically, the metering and assay stacks 224, 226 remain separated throughout the sample collection process. In such embodiments, the separation between the metering stack 224 and the assay stack 226 can prevent a chemical reaction from starting during the fluid sample collection step. When the spacer material 225 is compressed, the metering stack 224 and assay stack 226 can come into contact with or brought into close proximity to each other.

In preferred embodiments, when the metering stack 224 is fully filled with a biological fluid, the cartridge 200 is inserted into an assay reader. Preferably, the material that is used for the top surface of channel 230 is sufficiently transparent so that a user can determine by visual inspection when the channel 230 is filled and the cartridge 200 is ready for insertion into the assay reader. The assay reader is configured to accept the cartridge 200 and includes a mechanism that compresses the spacer material 225, thereby pushing the metering stack 224 and assay stack 226 together when the cartridge 200 is inserted into the assay reader. The compression of the spacer material 225 causes a predetermined volume of at least a portion of the collected fluid to flow to assay components in the assay stack 226. In this way, the act of compressing the metering stack 224 and assay stack 226 together can, in certain embodiments, provide a well-defined point in time that marks the start of the assay through the components in the assay stack 226. However, it is also to be understood that other insertion approaches are contemplated that do not require compression of the metering stack 224 and assay stack 226 together as would be understood by one of ordinary skill in the art.

In some embodiments, the fluid sample containing the target analyte is blood, and the cartridge 200 can be used to collect a sample of capillary blood from lanced skin and deliver the sample to the assay stack consistently with minimal user intervention. The user, with a regular pricking lancet, can elicit bleeding in a suitable body site such as a fingertip, palm, hand, forearm, abdomen, etc. Once a drop of blood of sufficient volume is on the skin, the user can collect it by touching the tip of the cartridge to the blood drop. Once the metering stack 224 is fully filled with blood, the user can insert the cartridge 200 into the assay reader, which triggers the delivery of the blood sample to the assay stack 226. In some embodiments, this can be performed by a patient, administrator, or healthcare provider. The blood collection and testing as described herein does not have to be performed by a trained healthcare professional.

In addition, the cartridge design can allow for dispensing different pre-defined volumes of blood sample to multiple assay locations, without using any moving parts such as pumps or valves in the cartridge 200 or in the assay reader. This increases the accuracy and flexibility of a multiplexed quantitative POC analysis, while reducing the complexity and cost of the cartridge and the assay reader.

Typically, as illustrated in FIG. 2C, the metering stack 224 includes a channel 230 to contain the biological fluid (e.g., a fluid sample containing a target analyte). In certain embodiments, the channel 230 can hold a volume of the fluid sample containing a target analyte in the range of about 0.5 μl to about 100 μl, about 5 μl to about 90 μl, about 10 to about 80 μl, about 20 μl to about 60 μl, or about 30 μl to about 50 μl. The volume of the fluid sample can be controlled by the dimensions of the channel, including the shape, width, length, and depth of the channel, as described herein. In some embodiments, the depth of the channel can be in the range of about 5 μm to about 3 mm, about 10 μm to about 2 mm, or about 250 μm to about 1 mm. In some embodiments, the width of the channel can be in the range of about 100 μm to about 10 mm, about 250 μm to about 5 mm, about 500 μm to about 3 mm, or about 750 μm to about 1 mm. In certain preferred embodiments, the dimensions of the channel are selected such that the biological fluid is drawn into the channel by capillary action.

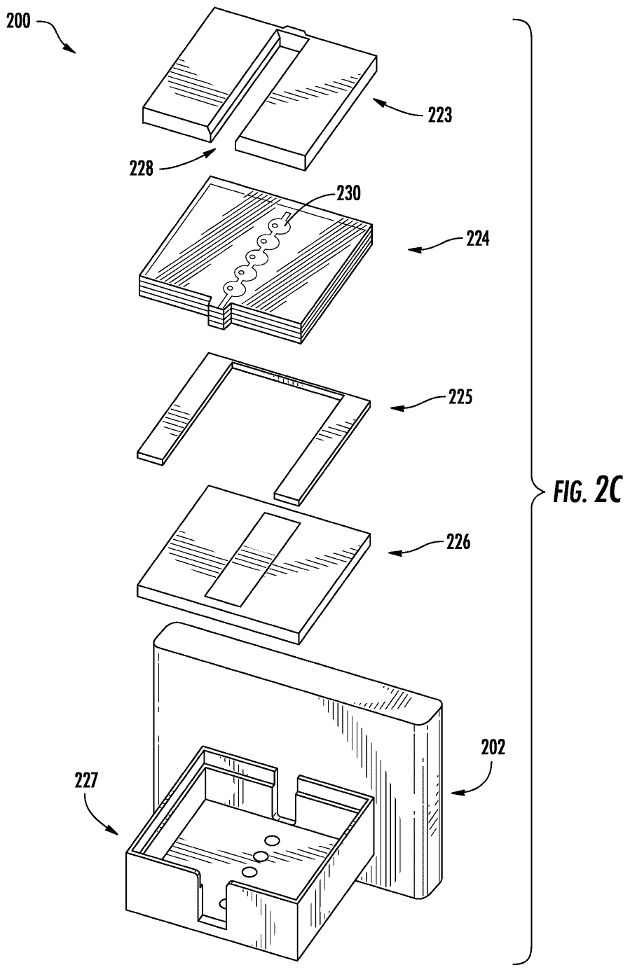

FIG. 3 illustrates an exploded view of a metering stack 304 according to one exemplary embodiment of the present disclosure, where such metering stack 304 can be used as metering stack 224 in the embodiment of FIGS. 2A to 2C. In FIG. 3, the metering stack 304 is formed by assembling multiple layers. The first layer 341 can be a plastic sheet with a first side 342, which is in communication with the surrounding environment when the cartridge is located outside the assay reader, and a second side 343 that faces the assay stack. In some embodiments, the first layer 341 may be a cover layer or top layer of the metering stack. In preferred embodiments, first layer 341 may have a hydrophilic surface or coating on second side 343. Non-limiting examples of suitable hydrophilic surfaces coatings include polyvinylpyrrolidone-polyurethane interpolymer, poly(meth)acrylamide, maleic anhydride polymers, cellulosic polymers, polyethylene oxide polymers, and water-soluble nylons or derivatives thereof, to name just a few. The presence of the hydrophilic surface or coating on second side 343 helps to draw the biological fluid (e.g., blood fluid sample) into the channel. The first layer 341 may include venting holes 311 positioned to align with the channel 310 defined by the layers below. In FIG. 3, for example, the venting holes 311 are aligned with the receiving chambers of channel 310 to allow air that otherwise would be trapped as an air bubble in the receiving chamber during channel filling to escape efficiently into the surrounding environment. It should be noted that the channel opening can also serve as a vent hole, if desired. In certain preferred embodiments, the first layer 341 includes polyethylene terephthalate (PET) with a hydrophilic coating on the second side 343 and venting holes 311.

The second layer 344 is positioned below the first layer 341 on the second side or assay facing side of the first layer 341. The second layer 344 itself can be a combination of one or more layers as illustrated in FIG. 3. Regardless of whether the second layer includes one layer or more than one layer, the second layer essentially defines the shape and size of the channel in the metering stack, including any receiving chambers that may be part of the channel. For example, the second layer 344 can be formed from one or more layers of polymeric material cut to define the volume and shape of the channel 310 that can contain the biological fluid (e.g., blood fluid sample). Other non-limiting methods of forming the channel 310 include injection-molding, stamping, machining, casting, laminating, and 3-D printing. Combinations of such fabrication techniques are also expressly contemplated by the present disclosure.

In the embodiment shown in FIG. 3, second layer 344 has a first side 347 facing the first layer 341 and an opposite, second side 348 that faces the assay stack. Furthermore, second layer 344 includes adhesive layer 345 and plastic layer 346. Adhesive layer 345 fastens the first layer 341 to plastic layer 346. In some embodiments, the second layer 344 can be a combination of one or more plastic layer(s) 346 and adhesive layers 345. Preferably, adhesive layer 345 or plastic layer 346 or both are fabricated from materials which present a hydrophilic surface to the interior surfaces of channel 310 in order to facilitate the distribution of the biological fluid within channel 310. In some embodiments, the hydrophilic plastic sheet(s) can include a PET material with a channel 310 cut into it. If desired, channel 310 may include one or more receiving chambers as shown in FIG. 3.

In FIG. 3, third layer 349 can be formed from a hydrophobic adhesive layer. Non-limiting examples of suitable materials for fabricating third layer 349 include 3 200MP adhesive or 3M 300MP adhesive (3M, Oakdale, MN). In preferred embodiments, the same channel geometry as channel 310 is cut into the third layer to match channel 310 cut in the second layer. In some embodiments, the third layer 349 can have a first side 351 facing the second layer 344 and a second side 352. In some embodiments, the third layer 349 can define the hydrophilic region in a fourth layer 350 positioned below or on the second side 352 of the third layer.

In some embodiments, the fourth layer 350, which can be positioned beneath only a portion of the receiving chambers of the channel 310, can be a hydrophilic mesh or porous material. In some embodiments, substantially all of the fourth layer 350 can include the mesh or porous material as shown in FIG. 3. In other embodiments, the hydrophilic mesh or porous material can be a portion of the fourth layer 350. In some embodiments, such as the example shown in FIG. 3, the fourth layer 350 can have a first side 353 facing the third layer 349 and an opposite assay stack-facing second side 354. The hydrophobic third layer 349 can be positioned above the fourth layer 350. The hydrophobic third layer 349 can be a hydrophobic adhesive layer to define a wettable region of the mesh or porous material of the fourth layer 350.

The method used to fabricate the metering stack is not particularly limited, so long as it is compatible with the general manufacturing requirements for medical devices. In certain embodiments, the layers that constitute the metering stack are first fastened together as a large multilayer sheet or strip which is then subjected to stamping or cutting processes to form the metering stack, including the channel and any receiving chambers that may be present. In some embodiments, the first layer 341 and second layer 344 can be combined in one piece of plastic material with a hydrophilic surface forming the channel. Various other combinations of two or more layers, as well as additional layers, are contemplated by various embodiments.

In the POC systems of the present disclosure, the assay reactions occur in the assay stack. In general, an assay stack includes one or more “assay components.” As used herein, the term “assay component” refers to one or more of the active component and a passive supporting element or mask, including but not limited to the multiplexed assay pads. The number of assay pads (e.g., separation membranes, detection membranes, etc.) in a particular assay component is not particularly limited but is based on the particular assay requirements needed to diagnose the condition or analyze the fluid sample of the patients for whom the assay stack is designed. In preferred embodiments, the layers of the assay pads of a given assay component align vertically with the appropriate regions of the channel in the metering stack above to ensure that a predetermined volume of a biological fluid, sufficient to perform the assay associated with the particular target analyte of interest, is delivered to the detection membrane. The assay pads can act as a wick that draws the sample through the metering stack into the assay stack, for example through capillary action. Therefore, once the metering stack and the assay stack are in contact with or within close proximity to each other, the biological fluid to be analyzed is directed to move into the detection membrane, where it may encounter one or more reagents required to perform the assay associated with the particular assay component. If desired, the assay stack may include additional layers that contain reagents required for the completion of the assay. The number of layers required can depend on the number of chemical reactions that need to take place in order to complete the assay. In various embodiments, layers of the assay stack can be made of variously shaped and variously sized pads of different porous membrane materials, non-limiting examples of which include a polysulfone, a polyethersulfone, nylon, cellulose (e.g., nitrocellulose, cellulose filter paper, etc.) and glass fiber.

The type of assays that may be performed using the assay systems of the present disclosure are not particularly limited and can be any assay for which the required reagents can be stably incorporated into one or more separation membranes and/or detection membranes and which can cause a change that can be detected by the assay reader. In some embodiments, the assay reactions cause a color change, which may be detected using the colorimetric detection methods as described herein. Still other assay reactions may result in another optical change, a fluorescence change, an electrochemical change, or any other detectable change that may occur in a detection membrane of the assay stack. In certain embodiments, the assays may be porous material-based lateral flow assays, vertical flow assays, and/or a combination of lateral and vertical flow assays. In general, the target analyte is contained within a biological fluid, non-limiting examples of which include blood, plasma, serum, saliva, sweat, urine, lymph, tears, synovial fluid, breast milk, and bile, or a component thereof, to name just a few. In certain preferred embodiments, the biological fluid is blood. For example, in one embodiment, the assay systems of the present disclosure are useful for providing patients with POC information regarding target analytes in their blood composition. In particular, the assay systems of the present disclosure can be used to determine the concentration of glucose and optionally other analytes in a fluid sample. Other analytes that can be measured in blood via other receiving chambers that may be present as part of the assay system include thyroid markers (e.g., T3, free T4, thyroid stimulating hormone, etc.), inflammatory markers (e.g., C-reactive protein, etc.), vitamins (detected via a competitive assay structure), cholesterol, lipoproteins, triglycerides, metabolic syndrome markers, hemoglobin, glycated albumin, and serological levels of antibodies against a disease (detected by a labeled antigen architecture).

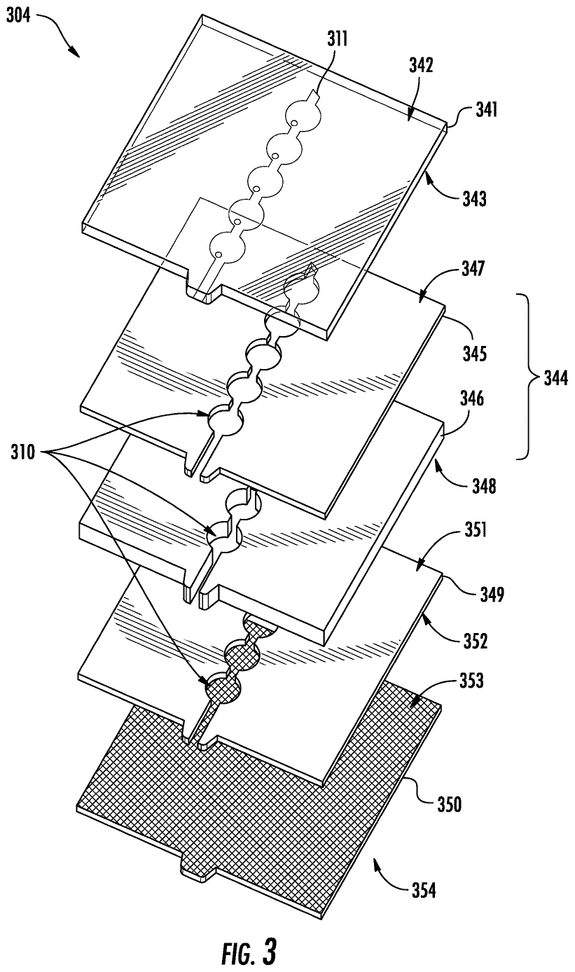

FIG. 4 illustrates an exemplary assay stack 406 according to one embodiment of the present disclosure, where such assay stack 406 can in particular be used as assay stack 226 in the embodiment of FIGS. 2A to 2C. In FIG. 4, the assay stack 406 is formed of multiple layers, including one or more of the layers with active components and a passive supporting element or mask. More specifically, in FIG. 4, assay stack 406 includes assay stack cover layer 410 that features a cut-out portion 411 that is aligned with the channel in the overlying metering stack. Generally, assay stack cover layer 410 is fabricated from a polymeric material that provides rigidity to the assay stack and provides ease of handling during manufacturing of the cartridge. Furthermore, the cut-out portion 411 allows the biological fluid to flow past the assay stack cover layer 410 towards the underlying assay components when the cartridge is inserted into the assay reader, as described herein.

As shown, the assay stack 406 includes a separation membrane 461 which can be the top-most layer facing the metering stack. The separation membrane 461 is used to separate components of the fluid sample to prevent undesirable components from reaching the underlying assay components. Such a separation membrane 461 can be made of a variety of materials, non-limiting examples of which include sulfone polymers, mixed cellulose esters, or a combination thereof as discussed in more detail below.

Still referring to FIG. 4, in some embodiments, the assay stack 406 can include an assay component 462 positioned below the separation membrane 461. The assay component 462 includes a mask support layer 450 with a plurality of cut-outs 451 that are configured to receive and immobilize detection membranes 463 when the assay stack 406 is assembled.

Detection membranes 463 (e.g., detection membranes such as but not limited to color generation membranes) may include reagents that are necessary to complete the assay reactions that are initiated once the target analyte (e.g., hemoglobin) flows through the separation membranes 461. In some embodiments, detection membranes 463 serve as a detection indicator layer that provides information corresponding to the results of the assay performed. For example, detection membranes 463 (e.g., color generation membranes) can include a visual indicator, such as a color change, to indicate the results of the assays, although it is to be understood that the detection membranes contemplated by the present disclosure also contemplate fluorescent and electrochemical changes or responses.

Furthermore, while assay stack 406 in FIG. 4 contains only assay component 462, it should be understood that the assay stack 406 may contain additional assay components with assay pads that are impregnated with the reagents required to complete and/or report the results of a particular assay. For instance, the assay stack 406 can include any number of assay components necessary to perform the analysis of the blood sample. Because some assays require more chemical steps than others, assay components may include more non-functional assay pads which only serve to draw the completed assay products to the bottom of the assay stack, where the results may be detected by the assay reader, as described herein.

Assay stack 406 in FIG. 4 also includes an assay bottom layer 470, which is typically fabricated from a polymeric material to provide mechanical strength and ease of handling of assay stack 406 during the manufacturing process. In addition, assay bottom layer 470 typically includes a plurality of detection ports 471 which are aligned with the detection membranes of the assay stack and sized to permit interrogation of the assay results by the assay reader.

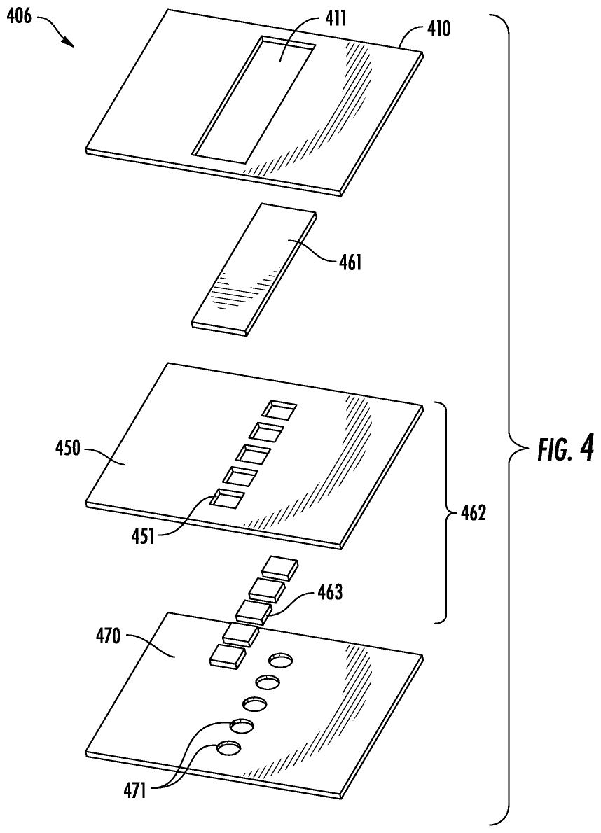

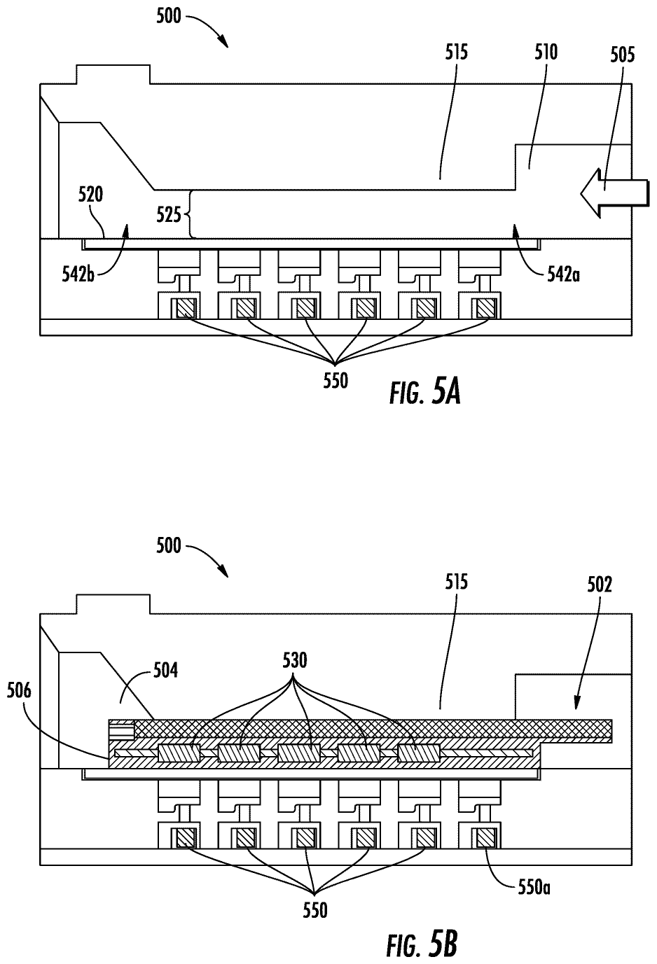

FIG. 5A shows a schematic drawing of an assay reader, in a longitudinal cross-section, according to one non-limiting embodiment of the present disclosure. In FIG. 5A, assay reader 500 includes cartridge receiving chamber 510 which houses the cartridge when it is inserted as indicated by arrow 505. Tab 515 runs longitudinally along assay reader 500 and extends into cartridge receiving chamber 510. Tab 515 is configured to insert into a slot at the top of the cartridge, such as slot 228 in FIG. 2C, when the cartridge is inserted into the assay reader. In addition, the spacing 525 between the bottom edge of tab 515 and support surface 520 is set such that when the cartridge is inserted, tab 515 compresses the metering stack and the assay stack together, thereby causing the biological fluid containing the target analyte to flow from the metering stack into the assay stack and initiating the assay reactions. In certain embodiments, the assay reader may include a snap-fit mechanism that locks the cartridge in place once it has been fully inserted into the assay reader. This is advantageous because it prevents the user from accidentally removing the cartridge from the assay reader before the assays are complete, which could adversely affect the accuracy of the assay results. In some embodiments, assay reader 500 also includes sensors 542a and 542b, which detect and time the insertion of the cartridge. For example, as the cartridge is inserted into cartridge receiving chamber 510 and begins to engage with tab 515, the bottom surface of the cartridge may pass over sensor 542a, which is detected by appropriate electronics as the beginning of the insertion of the cartridge. The second sensor 542b is located further inside the assay reader 500 and detects the presence of the cartridge when the cartridge is fully inserted as well as the time at which full insertion occurred. Assay reader 500 may then compare the overall time for insertion of the cartridge to determine if the insertion of the cartridge was timely and proper. In this way, the assay reader will not perform any assay readings in situations where (1) the cartridge was only partially inserted, or (2) the cartridge was partially inserted, removed, and inserted again. Either case could give inaccurate assay readings, due to the incomplete compression of the metering stack and assay stack, resulting in incomplete delivery of the required amount of target analyte to the detection membranes in the assay stack.

In the exemplary embodiment shown in FIG. 5A, assay reader 500 detects the results of the assay by detecting the color change of the detection membrane caused by the assay reactions. To achieve this, assay reader 500 includes a plurality of light sources (not shown in this cross-sectional drawing) and light detection elements 550 arrayed within assay reader 500 such that they align with the detection membranes located in the downstream direction of the cartridge compared to where the biological fluid sample is applied at an upstream location when the cartridge is fully inserted. In order for light detection elements 550 to be able to detect the color of the detection membranes, support surface 520 may be equipped with one or more apertures or be fabricated from a transparent material that allows light to penetrate therethrough. However, it is also to be understood that the assay reader 500 can alternatively include components to detect electrochemical or fluorescent changes in a detection membrane portion of the assay stack.

FIG. 5B shows a schematic illustration of a longitudinal cross-section of assay reader 500 with cartridge 502 fully inserted. Cartridge 502, which may correspond to cartridge 100 or 200 of FIG. 1 or FIGS. 2A to 2C, includes metering stack 504 and assay stack 506, which are compressed together by tab 515 such that the target analyte (e.g., glucose) is delivered from the metering stack 504 to the detection membranes 530. Detection membranes 530 are aligned with light detection elements 550. Note, however, that assay reader 500 may include an additional light detection element 550a without a corresponding detection membrane 530. The presence of additional light detection elements, such as light detection element 550a, allow the assay reader to be used with different types of cartridges for different assays, particularly cartridges that may be designed to perform more assays, as well as to identify the different types of cartridges for the different assays.

In particular, it is to be understood that the assay reader 500 of FIGS. 5A-5B can be utilized in reflectance spectroscopy to determine the concentration of the target analyte in the fluid sample that has been introduced upstream of the detection membrane, while the analysis is taken downstream where the detection membrane is located in the cartridge 502 since the device is a vertical flow assay device. As known by one of ordinary skill in the art, reflectance spectroscopy refers to measuring light as a function of wavelength that has been reflected or scattered from a surface, in this case the detection membrane. The use of reflectance spectroscopy lends itself well to POC diagnostics as it allows for dry chemistry techniques to be used in the manufacturing process, simplified design of the electronics, and the advantage of using a vertical flow architecture for sample collection and delivery. Further, reflectance spectroscopy does not require turbidity correction that is required in transmission spectroscopy, which can lead to erroneous results as discussed in detail above.

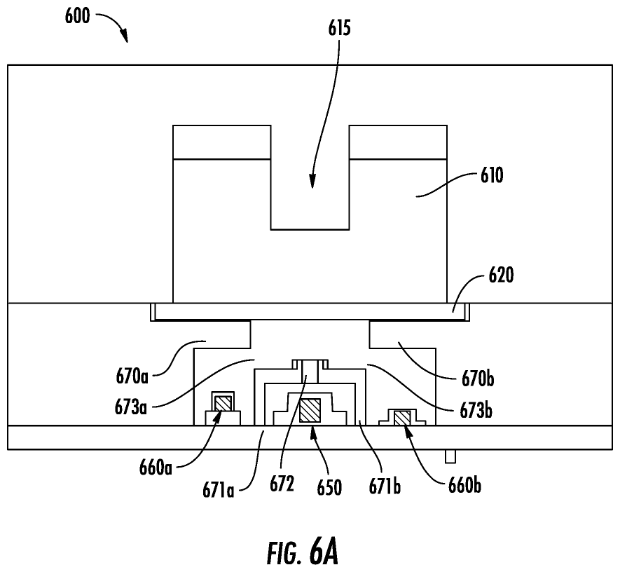

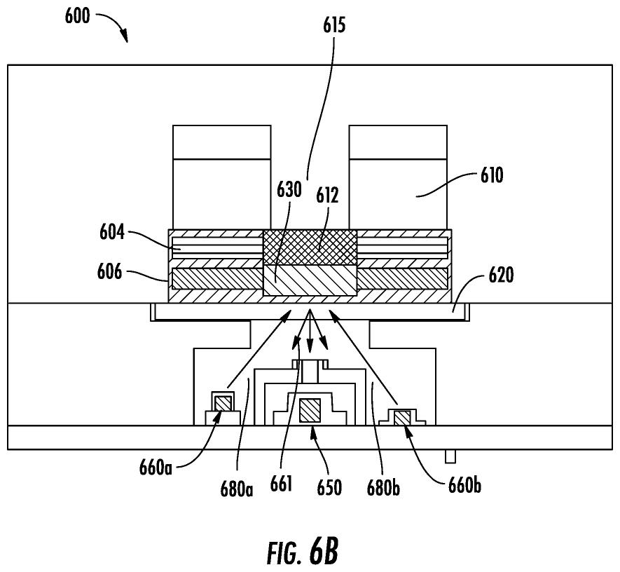

FIG. 6A shows a schematic drawing of a transverse cross-section of the assay reader shown in FIGS. 5A-5B in the form of an assay reader 600 that may be used to detect color changes. In FIG. 6A, the assay reader 600 includes a tab 615 that extends into cartridge receiving chamber 610 to engage with a slot on the cartridge. Such engagement then compresses the metering stack and the assay stack against support surface 620, initiating the assay reactions. Light sources 660a and 660b provide light for detecting the assay results and are positioned near light detection device 650. Specifically, as illustrated in FIG. 6A, light sources 660a and 660b provide light to analyze the detection membrane via reflectance spectroscopy corresponding to light detection device 650. In general, it is advantageous to dedicate one or more light sources to each light detection element in order to ensure that the photon flux onto the light detection element is sufficient to obtain an accurate reading. In some embodiments, the light sources dedicated to a particular light detection element have the same output spectrum. In other embodiments, however, the light sources corresponding to a given light detection element produce different output spectra.

For instance, the light sources may be light emitting diodes (LEDs) that produce different colors of light. In general, it is advantageous to include optical elements to direct the light and/or reduce the amount of light scattering in the assay reader. In some embodiments, the optical elements are apertures that only allow light emanating from the light source that is line-of-sight to the respective detection membrane to reach the detection membrane. For example, in FIG. 6A, light source 660a is limited by aperture defining members 670a and 671a such that only the light from light source 660a that passes through aperture 673a will reach the detection membrane and subsequently be detected by light detection device 650. Similarly, light source 660b is limited by aperture defining members 670b and 671b, such that only the light from light source 660b that passes through aperture 673b will reach the detection membrane and subsequently be detected by light detection device 650. In preferred embodiments, aperture defining members 670a, 670b, 671a, and 671b are fabricated from a black matte material to reduce the amount of undesirable scattering when light sources 660a and 660b are turned on. Furthermore, in this embodiment, light detection device 650 located in a housing includes aperture defining members 671a and 671b that only permit light that passes through aperture 672 to reach light detection device 650. If desired, the aperture 672 may be fitted with a filter to admit only light of a predetermined wavelength or wavelength range for detection by light detection device 650. This may be useful, for example, when the light sources are equipped to provide only white light for colorimetric analysis. In addition, the light from light sources 660a and 660b and the light to be detected by light detection device 650 may be directed or manipulated using optical elements such as lenses, filters, shutters, fiber optics, light guides, and the like without departing from the spirit and the scope of the present disclosure.

FIG. 6B shows a schematic illustration of the operation of the assay reader described in FIG. 6A. In FIG. 6B, a cartridge including metering stack 604 and assay stack 606 are inserted into cartridge receiving chamber 610 of assay reader 600. Tab 615 compresses metering stack 604 and assay stack 606 against support surface 620 to cause the fluid sample) to flow from the channel 612 into detection membrane 630.

As noted previously, assay reader 600 may be fitted with sensors to confirm that the cartridge has been inserted correctly and in a timely manner. Assay reader 600 may also be pre-programmed before sample collection, either by the user or during the manufacturing process, to illuminate the detection membranes at the appropriate time based on the type of cartridge being used. In this way, assay reader 600 collects assay data from detection membrane 630 only when the assay is completed. Alternatively, if desired, assay reader 600 may be configured to collect assay data from detection membrane 630 during the entire assay reaction after the cartridge has been inserted. As shown in FIG. 6B, light source 660a provides light beam 680a, which impinges on the bottom face of detection membrane 630 to produce reflected light beam 661. Similarly, light source 660b produces light beam 680b, which may impinge on the bottom of the detection membrane 630 to produce reflected light beam 661 at the same time as light source 660a or a different time, depending on the requirements of the assays being detected.

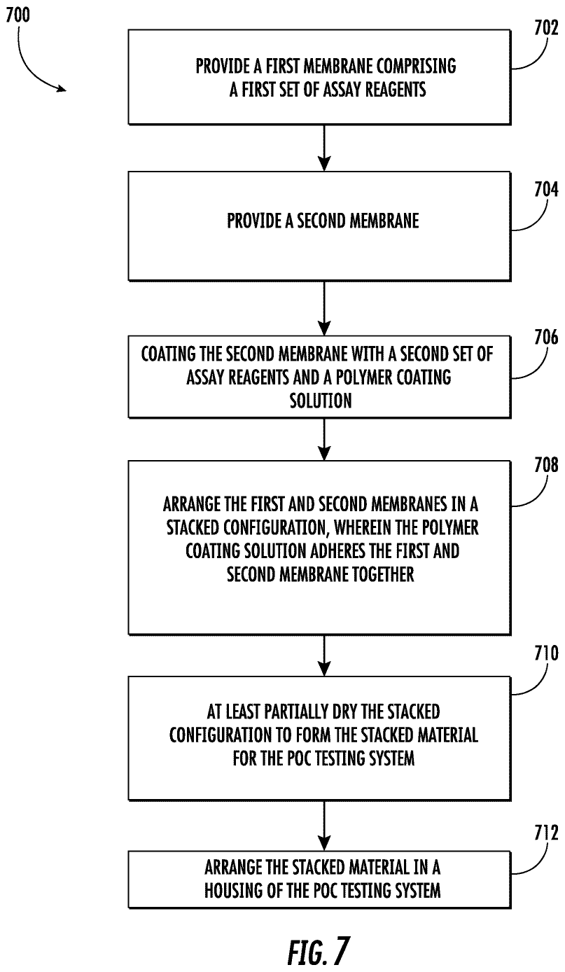

Referring now to FIG. 7, a flow diagram of an embodiment of a method 700 of manufacturing a stacked material for a POC testing system, such as the assay stack for the cartridge 200 depicted in FIGS. 1-6B, according to the present disclosure is illustrated. For example, the method 700 of the present disclosure is capable of manufacturing the assay stack 406 described herein. One skilled in the art, using the disclosures provided herein, will appreciate that various steps of the methods disclosed herein can be omitted, rearranged, combined, and/or adapted in various ways without deviating from the scope of the present disclosure.

As shown at (702), the method 700 includes providing a first membrane comprising a first set of assay reagents. As shown at (704), the method 700 includes providing a second membrane. As shown at (706), the method 700 includes coating the second membrane with a second set of assay reagents and a polymer coating solution. In certain embodiments, for example, coating the second membrane with the second set of assay reagents and the polymer coating solution may include applying the second assay reagent and the polymer coating solution to a use area of the second membrane. As used herein, the use area generally corresponds to an area of the assay stack in which a fluid sample passes therethrough during operation of the POC testing system.

As shown at (708), the method 700 includes arranging the first and second membranes in a stacked configuration, wherein the polymer coating solution adheres the first and second membranes together.

As shown at (710), the method 700 includes at least partially drying the stacked configuration to form the stacked material for the POC testing system. In such embodiments, at least partially drying the stacked configuration may be accomplished e.g., via active or passive heating (such as via a heater, an oven, or an environment having an elevated temperature), active or passive airflow (such as via ambient air or a fan), or any other suitable means. Moreover, in an embodiment, at least partially drying the stacked configuration may include maintaining the stacked configuration at a temperature of approximately 40 degrees Celsius (° C.) to approximately 120° C., such as approximately 50° C. to approximately 110° C., such as approximately 60° C. to approximately 100° C., for a certain time period. For example, in an embodiment, the stacked configuration may be maintained at the aforementioned temperature for at least about 3 minutes, such as at least about 5 minutes, such as at least about 15 minutes.

Accordingly, after drying and referring still to FIG. 7, as shown at (712), the method 700 includes arranging the stacked material in a housing of the POC testing system. In such embodiments, the stacked material may be placed in the housing of the POC testing system manually or automatically.

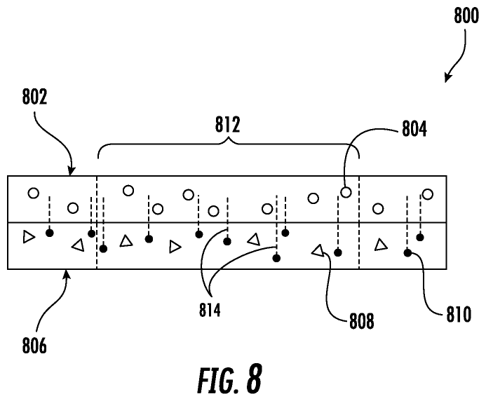

Referring now to FIG. 8, a cross-sectional view of an embodiment of a stacked material 800 for a POC testing system manufactured using the methods according to the present disclosure described herein is illustrated. In particular, as shown, the stacked material 800 includes a first membrane 802 containing a first set of assay reagents 804 and a second membrane 806 arranged in a stacked configuration with the first membrane 802. Further, as shown, the second membrane 806 has a second set of assay reagents 808. Moreover, as shown, the stacked material 800 includes a polymer coating solution 810 blended with one of the first and/or second sets of assay reagents 804, 808. In particular embodiments, as an example, the polymer coating solution 810 may be blended with the second set of assay reagents 808 of the second membrane 806 as indicated by the solid circles in FIG. 8. Thus, during the manufacturing process as described herein, the polymer coating solution 810 uniformly adheres the first and second membranes 802, 806 together, such as across their entire surface areas. For example, as shown in FIG. 8, after the first and second membranes 802, 806 are stacked together, the polymer coating solution 810 formed bridges across the two layers as shown by dotted lines 814. Accordingly, the polymer coating solution 810 being present in at least one of the first or second membranes 802, 806 is a core mechanism by which the adhesion between the layers takes place.

Furthermore, in certain embodiments, as shown in FIG. 8, by applying the second assay reagent 808 and the polymer coating solution 810 to the second membrane 806 as described herein, the adhesion between the first and second membranes 802, 806 extends across a use area 812 of the first and second membranes 802, 806. As used herein, the use area 812 generally corresponds to an area of the assay stack in which a fluid sample passes therethrough during operation of the POC testing system. Thus, by extending across the use area 812, the stacked material 800 of the present disclosure provides improved adhesion between the layers, as compared to stacked materials having adhesion only around the edges of the material. Furthermore, the overall efficiency of the manufacturing process is improved by not requiring an additional adhesion step or an alignment step. Moreover, an additional, separate adhesion layer is not required in the final stacked material, as shown in FIG. 8, thereby allowing a fluid sample, such as those described herein, to uniformly pass through the various layers of the stacked material 800.

Accordingly, the first and second membranes 802, 806 may be selected so as to function within a POC testing system that implements a vertical flow assay (also referred to herein as a vertical flow assay device). For example, the first and second membranes 802, 806 may be semi-permeable to allow a fluid sample and/or target analyte to selectively pass therethrough when the POC testing system implements a vertical flow assay. More specifically, in an embodiment, at least one of the first and/or second membranes 802, 806 may be a hydrophilic polymer, such as any of those described herein or known in the art.

In other embodiments, the polymer coating solution 810 described herein can be selected to function within a vertical flow assay device. For example, in certain embodiments, the polymer coating solution 810 may be a hydrophilic polymer, such as any of those described herein or known in the art. Non-limiting examples of hydrophilic polymers may include, for example, carboxymethyl cellulose, polyvinyl alcohol, polyethylene glycol, or combinations thereof.

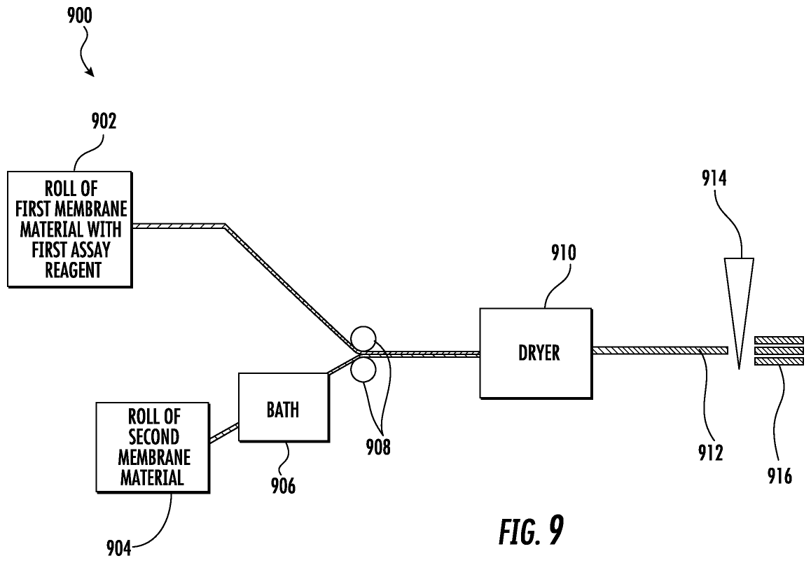

Referring now to FIG. 9, a schematic diagram of an embodiment of a system 900 for manufacturing a stacked material for a POC testing system, such as a vertical flow assay device is illustrated. As shown, the system 900 generally includes a roll 902 of the first membrane material and a roll 904 of the second membrane material. Accordingly, in such embodiments, the rolls 902, 904 of the first and second membrane materials provide each of the materials in bulk that can be easily fed into the process described herein.

In additional embodiments, as shown and described herein, the first membrane material may already contain a first set of assay reagents, i.e., before the manufacturing process begins. In addition, as shown, the second membrane material may not contain a second set of assay reagents. Thus, in an embodiment, as shown at 906, the process may include passing the second membrane material through a bath to coat the second membrane material with the second assay reagent. In such embodiments, as described herein, the second assay reagent may be mixed or blending with a polymer coating solution. Alternatively, both the first and second membrane materials may not initially include their respective assay reagents. In such embodiments, the process may include coating both of the first and second membrane materials with their respective assay reagents, one or both, as well as the polymer coating solution.

Still referring to FIG. 9, as shown at 908, the process further includes arranging the first and second membranes in a stacked configuration, wherein the polymer coating solution adheres the first and second membranes together. In particular, as shown, the first and second membranes are arranged together in the stacked configuration via at least one roller 908. For example, as shown in FIG. 9, the process of arranging the first and second membranes in the stacked configuration may include passing the first and second membranes together through at least two rollers 908 that are configured to laminate and/or adhere the first and second membranes together. It should be understood that such lamination may be accomplished through a variety of other means in addition to rollers, such as via one or more presses and/or manual placement. Moreover, lamination can be further enhanced by applying heat or thermal energy to the first and second membranes and/or the roller(s) as needed.

In addition, as shown at 910 in FIG. 9, the stacked configuration of the first and/or second membranes may be at least partially dried to form the stacked material 912 for the POC testing system. In particular, the stacked configuration can be dried via a dryer 910 or any other suitable means, such as passive drying. In such embodiments, as explained and described herein, the dryer 910 may be configured to provide a specific temperature for a specific amount of time to dry the stacked configuration. For example, the dryer 910 may be configured to provide a temperature of approximately 40° C. to approximately 120° C., such as approximately 50° C. to approximately 100° C., such as approximately 60° C. to approximately 90° C. Further, the dryer 910 may be configured to provide the temperature for at least about 3 minutes, such as at least about 5 minutes, such as at least about 15 minutes.

Furthermore, in an embodiment, as shown at 914, the process may optionally include cutting or trimming the stacked material 912 into a plurality of sheets 916 to form the stacked material, such as the assay stack 406. In such embodiments, the stacked material 912 may be cut/trimmed using a variety of means, such as via a shear, a laser, or similar.

### Additional Disclosure

While various embodiments of the present disclosure have been described above, it should be understood that they have been presented by way of example only, and not by way of limitation. Likewise, the various diagrams may depict an example architectural or other configuration for the disclosure, which is done to aid in understanding the features and functionality that can be included in the disclosure. The disclosure is not restricted to the illustrated example architectures or configurations but can be implemented using a variety of alternative architectures and configurations. Additionally, although the disclosure is described above in terms of various exemplary embodiments and implementations, it should be understood that the various features and functionality described in one or more of the individual embodiments are not limited in their applicability to the particular embodiment with which they are described. They instead can be applied, alone or in some combination, to one or more of the other embodiments of the disclosure, whether or not such embodiments are described, and whether or not such features are presented as being a part of a described embodiment. Thus, the breadth and scope of the present disclosure should not be limited by any of the above-described exemplary embodiments.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

### Privacy

It should be understood that blood collection may include sensitive and confidential information relating to a user, such as DNA/genetic predispositions, pregnancy, etc. Accordingly, and further to the descriptions above, all samples (e.g., such as blood samples) and related information acquired using the products or end products of the aforementioned systems and methods will be kept private and confidential. Thus, it should not be construed that any information discovered or inferred from the use of the products or end products produced using the aforementioned systems and methods will be improperly used or published. For example, information acquired from a POC testing system may be treated so that no person without express or implied consent is capable of accessing said information. Thus, the information acquired from a POC testing system may be kept confidential and access to the information may be controlled exclusively by the user of the POC testing system whose information is determined by using the POC testing system.

What is claimed is:

1. A method of manufacturing a stacked material for a point-of-care (POC) testing system, the method comprising:
providing a first membrane comprising a first set of assay reagents;
providing a second membrane;
coating the second membrane with a second set of assay reagents and a polymer coating solution;
arranging the first and second membranes in a stacked configuration, wherein the polymer coating solution adheres the first and second membranes together; and
at least partially drying the stacked configuration to form the stacked material for the POC testing system.

2. The method of claim 1, wherein at least one of the first membrane and the second membrane is semi-permeable.

3. The method of claim 1, wherein at least one of the first membrane and the second membrane comprises at least one of a sulfone polymer, a cellulose ester, or combinations thereof.

4. The method of claim 1, wherein the polymer coating solution comprises at least one of polyvinyl alcohol, a substituted polysaccharide, polyethylene glycol, or combinations thereof.

5. The method of claim 1, wherein coating the second membrane with the second set of assay reagents and the polymer coating solution further comprises:
applying the second set of assay reagents and the polymer coating solution to a use area of the second membrane, the use area corresponding to an area of the stacked material in which a fluid sample passes therethrough during operation of the POC testing system.

6. The method of claim 1, wherein coating the second membrane with the second assay reagent and the polymer coating solution further comprises passing the second membrane through a bath containing the second reagent and the polymer coating solution.

7. The method of claim 1, wherein arranging the first and second membranes in the stacked configuration further comprises laminating the first and second membranes together by passing the first and second membranes through a roller.

8. The method of claim 1, wherein arranging the first and second membranes in the stacked configuration further comprises aligning the first and second membranes with each other and maintaining alignment of the first and second membranes until after at least partially drying.

9. The method of claim 1, wherein at least partially drying the stacked configuration further comprises maintaining the stacked configuration at a temperature of approximately 40 degrees Celsius (° C.) to approximately 100° C. for a certain time period.

10. The method of claim 1, further comprising cutting the stacked configuration into a desired shape to form the stacked material.

11. The method of claim 1, wherein the POC testing system is configured to implement a vertical flow assay, wherein the stacked material is an assay stack of the POC testing system for implementing the vertical flow assay.

12. A stacked material for a point-of-care (POC) testing system, the stacked material comprising:
a first membrane comprising a first set of assay reagents;
a second membrane arranged in a stacked configuration with the first membrane, the second membrane comprising a second set of assay reagents; and
a polymer coating solution blended with at least one of the first set of assay reagents and the second set of assay reagents,
wherein the polymer coating solution adheres the first and second membranes together.

13. The stacked material of claim 12, wherein at least one of the first membrane and the second membrane is semi-permeable, wherein at least one of the first membrane and the second membrane comprises at least one of a sulfone polymer, a cellulose ester, or combinations thereof, and wherein the polymer coating solution comprises at least one of polyvinyl alcohol, a substituted polysaccharide, polyethylene glycol, or combinations thereof.

14. The stacked material of claim 12, wherein the POC testing system is configured to implement a vertical flow assay, and wherein the stacked material is an assay stack of the POC testing system for implementing the vertical flow assay.

15. The stacked material of claim 12, wherein the polymer coating solution blended with at least one of the first set of assay reagents and the second set of assay reagents is present in a use area of the stacked material, the use area corresponding to an area of the stacked material in which a fluid sample passes therethrough during operation of the POC testing system.

16. A method of manufacturing a point-of-care (POC) testing system configured to implement a vertical flow assay, the method comprising:
providing a first membrane comprising a first set of assay reagents;
providing a second membrane;
coating the second membrane with a second set of assay reagents and a polymer coating solution;
arranging the first and second membranes in a stacked configuration, wherein the polymer coating solution adheres the first and second membranes together;
at least partially drying the stacked configuration to form an assay stack; and
arranging the assay stack in a housing of the POC testing system configured to implement the vertical flow assay.

17. The method of claim 16, wherein coating the second membrane with the second set of assay reagents and the polymer coating solution further comprises passing the second membrane through a bath containing the second reagent and of the polymer coating solution.

18. The method of claim 16, wherein arranging the first and second membranes in the stacked configuration further comprises laminating the first and second membranes together by passing the first and second membranes through a roller.

19. The method of claim 16, wherein coating the second membrane with the second set of assay reagents and the polymer coating solution further comprises:
applying the second set of assay reagents and the polymer coating solution to a use area of the second membrane, the use area corresponding to an area of the assay stack in which a fluid sample passes therethrough during operation of the POC testing system.

20. The method of claim 16, wherein at least partially drying the stacked configuration further comprises maintaining the stacked configuration at a temperature of approximately 40 degrees Celsius (° C.) to approximately 100° C. for a certain time period.
